(19) United States
(12) Patent Application Publication
(10) Pub. No.: US 2026/0371029 A1
(43) Pub. Date: Nov. 19, 2026

(54) Method and System for Multi-Device Playback

(71) Applicant: Bang & Olufsen A/S, Struer (DK)

(72) Inventors: Jonathan FRANCOMBE, Struer (DK); David GEARY, York (GB); Christopher GRIBBEN, Struer (DK)

(21) Appl. No.: 19/477,704

(22) PCT Filed: May 3, 2024
(86) PCT No.: PCT/EP2024/062327

§ 371 Date: Oct. 22, 2025

(30) Foreign Application Priority Data
May 4, 2023 (DK) PA 2023 30015

(51) Int. Cl. H04S 7/00; H04R 5/02; H04R 5/033; H04S 1/00; H04S 3/00

(52) U.S. Cl. CPC H04S 7/304; H04R 5/02; H04R 5/033; H04S 1/007; H04S 3/008; H04S 2400/01; H04S 2400/11; H04S 2420/01

(57) ABSTRACT

A method for playing back an input audio content on a multi-device audio comprising a pair of audio wearables and a loudspeaker system including at least one external loudspeaker. The method comprises transforming the audio content into a first two-channel audio signal and a second audio signal, playing back the first audio signal by the loudspeakers of the audio wearables, and playing back the second audio signal by the loudspeaker system to reach the listener over an acoustic channel via the audio wearables, the acoustic channel associated with an overall transfer function comprising an active transfer function and a position dependent transfer function associated with the position of the audio wearables relative to the external loudspeaker(s), and based on characteristics of the second audio signal and/or the overall transfer function, processing the first audio signal and/or the second audio signal, in order to achieve the desired audio experience.

### TECHNICAL FIELD OF THE INVENTION

The present disclosure relates to playback of a first and second audio signal (A, B) on a multi-device audio system.

### BACKGROUND OF THE INVENTION

Today, devices capable of playing back audio are widespread in both public and private areas. For example, in a single household there may be multiple dedicated loudspeakers, portable battery-powered loudspeakers (such as Bluetooth speakers), smartphones equipped with loudspeakers, tablets equipped with loudspeakers, TV sets equipped with loudspeakers or even loudspeakers integrated into the walls or ceilings. The omnipresence of connected devices capable of playing back audio introduces an opportunity for providing multi-device audio experiences that employ multiple standalone devices which cooperate to reproduce new types of audio experiences. Several systems and production tools for authoring and delivering such experiences have been developed.

As loudspeaker equipped devices have become smaller and more widespread, various forms of interactive audio experiences have emerged. For example, wearable loudspeakers have been used in augmented/virtual reality games to enhance immersion.

However, due to the complexity of multi-device audio experiences many existing solutions fail to fully leverage the capabilities of individual loudspeakers whereby the resulting listening experience is suboptimal. Notably it has proven difficult to incorporate widely different audio playback devices to contribute to an integrated listening experience since the playback properties of the different devices could vary to a large extent.

There is therefore a need for a new and improved method for processing audio that helps achieve a more immersive multi-device listening experience that leverages the capabilities of different playback devices.

### GENERAL DISCLOSURE OF THE INVENTION

It is an object of the present invention to provide an improved approach to process audio which is played back on a multi-device audio system. This and other objects are achieved by a method and system as defined by the independent claims.

One aspect of the invention relates to a method for playing back an input audio content on a multi-device audio system to achieve a desired audio experience of a listener, the multi-device audio system comprising a pair of audio wearables and a loudspeaker system including at least one external loudspeaker, wherein each audio wearable comprises a microphone configured to capture audio of a listener environment and a transducer configured to play back audio content, wherein the audio wearables are configured to operate in an active mode wherein audio captured by the microphone is processed by an active filter having an active transfer function, and wherein an output of the active filter is connected to the transducer of the audio wearable. The method comprises transforming the audio content into a first two-channel audio signal (A) and a second audio signal (B), playing back the first audio signal (A) by the loudspeakers of the audio wearables, and playing back the second audio signal (B) by the loudspeaker system to reach the listener over an acoustic channel via the audio wearables, the acoustic channel associated with an overall transfer function comprising the active transfer function and a position dependent transfer function associated with the position of the audio wearables relative to the external loudspeaker(s), and based on characteristics of the second audio signal (B) and/or the overall transfer function, processing the first audio signal (A) and/or the second audio signal (B), in order to achieve the desired audio experience.

With this approach, information about how the audio content has been transformed into two signals, as well as information about the overall transfer function (including the active transfer function of the wearables) may be used to further adjust the two audio signals.

The method may include receiving input (feedback) associated with parameters impacting the overall transfer function, and estimating the characteristics of the overall transfer function based on said input. The input may be of various kinds, including position data describing a position of the listener with respect to the external loudspeaker(s), position data describing a position of the external loudspeaker(s) with respect to the room, orientation data describing a head pose of the listener, and/or an indication of a current operating mode of the audio wearables.

Wearables typically have an impact on how a listener receives sound from the environment, including from the loudspeaker system. The overall transfer function may therefore further comprise a passive transfer function representing this impact. In this case, the input may include information related to an occluding effect of the wearables, based on e.g., the type of wearables and their position.

In some embodiments, also the active transfer function may be controlled in order to achieve the desired audio experience. Such control may involve controlling the operation mode of the wearables, or a more complex control of the properties of the transfer function.

### BRIEF DESCRIPTION OF THE DRAWINGS

The present invention will be described in more detail with reference to the appended drawings, showing currently preferred embodiments of the invention.

FIG. 1 is a schematic illustration of audio signal reaching a listener.

FIG. 2 is a block diagram of an audio system implementing an embodiment of the present invention.

### DETAILED DESCRIPTION OF PREFERRED EMBODIMENTS

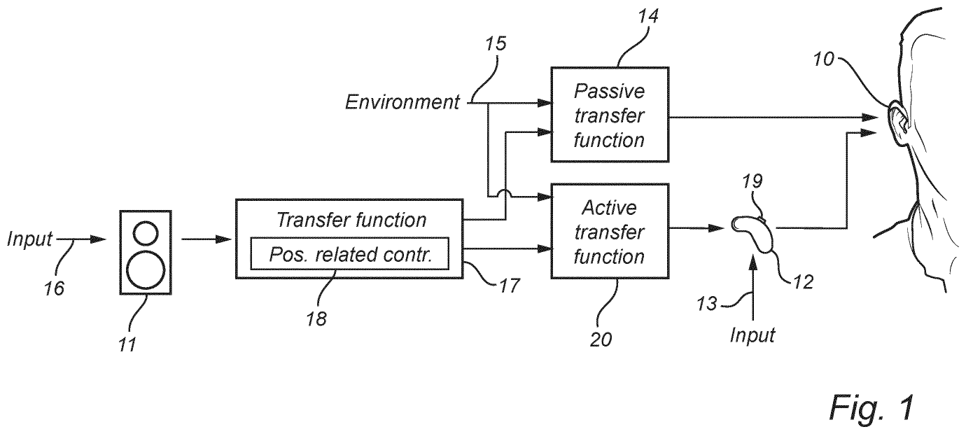

The listener 10 in FIG. 1 (represented by an ear) is located in a room or other space, equipped with a loudspeaker system 11 including at least one external loudspeaker. Further, the listener 10 is wearing audio wearables 12, such as earbuds, a headset, over-ear headphones, etc. The wearables typically have a loudspeaker or other transducer (e.g., a bone conduction transducer) for each ear. The wearables receive an input 13, and play back this input as sound directly into the ear of the listener 10.

There could be more than one listener 10 in the room. Also, although the present disclosure is directed to listener(s) 10 with wearables 12, it is possible that there is also one or several additional listeners in the room that are not wearing wearables.

Depending on the type of wearables, the wearables will in many cases obstruct the outer ears of the user, and to some extent impact external sound that is perceived by the listener. This effect is illustrated by a “passive transfer function” 14. Any environmental sound 15 (e.g. background noise, other people talking, vibration from appliances, etc.) will pass through the passive transfer function 14 before being perceived by the listener 10.

An input 16 is reproduced by the loudspeaker system 11. Sound from the loudspeaker system 11 will also pass through the passive transfer function 14 before being perceived by the listener 10. Before reaching the wearables 12 and the ear of the listener 10, the sound will also be subject to a “room transfer function” 17. The room transfer function 17 is sometimes referred to as a “room impulse response” and will include various contributions. One specific contribution 18 depends on the relative position of the listener 10 with respect to the loudspeaker(s) of the loudspeaker system 11. Examples of factors impacting this contribution include the positioning of the loudspeaker(s) in relation to each other, to the room (walls, furniture, etc.) and to the listener 10, but also the orientation of the listener 10, in particular of the listener's head.

The audio wearables 12 are active, implying that they include at least one microphone 19, configured to pick up sound from the environment and reproduce this sound through the loudspeakers of the audio wearables after some type of processing. The processing is associated with an active transfer function 20, the properties of which may be fixed or may be determined by user preferences. An example of active wearables is noise cancelling wearables, where the active transfer function 20 is configured such that sound picked up by the microphone(s) 19 to some extent is cancelled by a corresponding signal in anti-phase.

Wearables with active noise cancelling (ANC) sometimes allow a user to select operating mode, for example deactivating the noise cancelling (i.e. by-passing the active transfer function) or selecting a “transparency mode”. In transparency mode, the active transfer function 20 may have the opposite effect compared to noise cancelling mode, and rather serve to reproduce any sound picked up by the microphone(s) 19. The active transfer function 20 is typically frequency dependent, such that for example in noise cancelling mode, speech can still be perceived by the listener 10.

So, in summary, the listener will receive sound from three different sources (environment, loudspeaker input, wearables input), and via four different paths:
1. Environmental sound 15, perceived through the passive transfer function 14.
2. Input 16, played back by the loudspeaker system 11, subject to the room transfer function 17, and perceived though the passive transfer function 14.
3. Input 16, played back by the loudspeaker system 11, subject to the room transfer function 17, processed by the active transfer function 20 and then played back by the wearables 12.
4. Input 13 played back by the wearables 12.

The second and third paths, which both relate to the input 16 to the loudspeaker system 11, may be represented by one single “overall” transfer function, including contributions from the room transfer function 17, passive transfer function 14 and active transfer function 20.

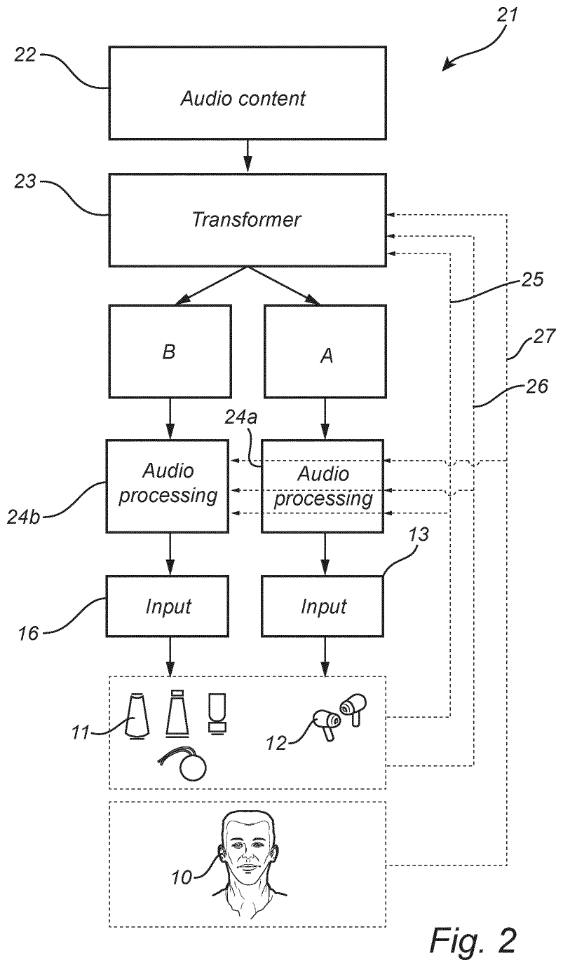

Turning to FIG. 2, there is illustrated an audio system 21 conveying an audio content 22 to the listener 10 located in an audio environment as discussed in relation to FIG. 1. The system generally includes an audio content transformer 23 and two separate audio processing paths 24a, 24b.

The audio content 22 may include several contributions in various formats, including stereo, binaural, MPEG-H, Dolby AC4. The audio content 22 might be purpose designed and therefore represented in some object-based format, or it might be standard content such as a channel-based mix (including the output of some object-based decoding e.g. Dolby Atmos to 7.1.4). Consequently, the audio content 22 may include a mix of audio channels and audio objects. The audio objects include audio signals and associated position metadata describing the location and other properties of the audio object.

The transformer 23 is configured to render the channels and objects of the audio content 22 into two separate audio signals; one signal A intended for playback on the wearables 12, and one signal B intended for playback on the loudspeaker system 11. The transformer 23 implements an allocation algorithm which takes in the audio signals and metadata, and chooses which audio signals to send to which loudspeakers. The transformer 23 may also render the audio signals to match the existing playback hardware. Signal A will typically be a stereo (or binaural) signal, while signal B will have a number of channels corresponding to the number of loudspeakers in the loudspeaker system 11.

The allocation algorithm implemented by the transformer 23 may involve a range of different types of processing. A simple approach could be determining whether a specific signal should be sent to the loudspeakers (signal B), to the wearables (signal A), or both. A more complex approach could distinguish between any available loudspeakers.

The processing paths 24a, 24b are configured to process the signals A and B and output processed versions of signals A and B. The processing is generally intended to ensure a satisfactory listening experience, based on input received from the system. The processed signals are provided as inputs 16 and 13 to the loudspeaker system 11 and to the wearables 12, respectively.

Also illustrated, very schematically, in FIG. 2 are three feedback paths 25, 26, 27 from the loudspeaker system 11, the wearables 12 and the listener 10, respectively. Feedback 25 from the loudspeaker system may include relative locations of all loudspeakers in the system, determined e.g. by ultrawideband (UWB) ranging devices provided on the loudspeakers. Feedback 25 may also include other information describing the configuration of the loudspeaker system 11, e.g. the number and type of loudspeakers. Feedback 26 may include the type and configuration of the wearables, e.g. if they are in-ear or over-ear, if they have loudspeakers or bone conducting transducers, etc. Feedback 26 may also include the operating mode of the wearables, e.g. if the wearables are operated in active noise cancelling (ANC) mode or transparent mode. Feedback 27 may include the location and/or head pose of the listener, determined e.g. by an Inertial Measurement Unit (IMU) carried by the listener.

Feedback 25, 26, 27 may be received by the processing paths 24a, 24b as well as by the transformer 23, in order to modify the processing therein. Some feedback may be single instance feedback, such as system configuration information collected at start-up. Other feedback may be reoccurring or continuous, such as head tracking and wearable settings.

Some example processing will be discussed in the following.

The allocation of signal A to the wearables 12 and signal B to the loudspeaker system may be influenced e.g., by the following information:
Metadata in feedback 25, 26 describing the loudspeaker system and wearables.

Such metadata could include, for each loudspeaker: position, frequency response, bass capability, max. sound pressure level, battery level, frequency response, directivity.
Properties of the audio content 22. For example, signals that are identified as speech could be sent to the wearables 12 (signal A). Analysis of the diffuseness or decorrelation in the signals could be performed, and highly diffuse signals sent to the loudspeaker system 11 (or to the wearables 12). Analysis of the frequency content of the signals could be performed, and signals with a lot of low-frequency content sent to the wearables 12 in situations where the loudspeaker system 11 does not have high bass capability.
The spatial properties of the available devices. The wearables 12 could use binaural rendering to simulate sound coming from the same position as the available loudspeakers. The wearables 12 could use binaural rendering to simulate sound coming from positions at which there was no loudspeaker.
Choices made by the listener 10 or data held about the listener. The listener could indicate their preferences using an app. A particular language could be selected based on the user.
The latency and/or synchronization accuracy of the devices available in the system. If the synchronization accuracy was unknown, then only audio objects for which some delay was acceptable could be routed to such devices. If the synchronization accuracy was known, this could be used to determine appropriate objects to send.
Choices made by the content author (e.g., as discussed in https://bbc.github.io/bbcat-orchestration-docs/).

In the processing paths 24a, 24b signals A and B are processed to improve the listening experience based e.g., on feedback 25, 26, 27. The processing could be applied at object-level, i.e., on individual signals, at channel level, i.e., on the combination of signals sent to an individual loudspeaker or wearable device, at the device-type level, i.e., on the combination of signals sent to the wearables 12 or to the loudspeaker system 11.

As discussed above, the wearables will modify the transfer function between the loudspeaker system 11 and the listener. Firstly, by introducing the passive transfer function 14 caused by occlusion of the ear. Secondly, by introducing the active transfer function 20 caused by the active reproduction of sound in the wearables 12. The signal B may be processed by processing path 24b in order to compensate for this modification. For example, by changing the level of the loudspeaker signals, changing the magnitude response of the loudspeaker signals, changing the spatial properties of the loudspeaker signals (e.g., the loudspeaker beam width), changing some signal processing applied to the loudspeaker signals, e.g., adding compression or reverberation.

Potential limitations of transparency mode in the wearables 12 may be counteracted in various ways. The transparency microphones 19 can be noisy, which reduces the amount of gain that can be applied. Modifying the level of the sound generated by the external loudspeakers could help to mitigate this (i.e., by requiring less gain in the transparency microphones). Latency caused by the active reproduction may be reduced by applying correction on the external loudspeakers rather than in the transparency pipeline.

The spatial properties of the listen-through sound (sound reproduced by the loudspeaker system 11 and received by the listener 10) will be influenced by the relative positioning of the wearable's microphones 19 with respect to the loudspeakers in the loudspeaker system 11. Information about this positioning may be obtained by feedback 25, 26, 27. Based on this feedback, the spatial resolution of the external loudspeaker rendering may be reduced when transparency mode is active (for example, using wide directivity modes rather than narrow directivity modes, using lower orders of ambisonics decoding, or using fewer loudspeakers in order to save power or leak less sound into the space). Further, the relative levels (or frequency-dependent levels) of devices may be altered based on their position in the room and the spatial impact of the transparency mode. Reverberation may be added to the external loudspeakers to compensate for any reduced externalization of sounds in transparency mode. Sounds played over the headphones may be mixed into the loudspeaker system in order to increase the sense of externalizations.

The fit of the wearables 12 may vary over time. This can result in variation in performance of transparency and/or ANC (for example in the degree of transparency, its frequency response, and/or its directivity). Information about such temporal variation, obtained by the feedback 26 or 27, could be used to adapt the rendering to compensate for or mitigate these variations.

Transparency mode has a certain spatial response, i.e., it is more or less transparent depending on the angle of incidence and the frequency content of the external sound. Information about the response, obtained by feedback 26 or 27, allows us to adjust the processing 24b. For example, the level of the external loudspeakers may be increased in the less transparent spatial region of the wearables. Further, important sounds that are routed to the loudspeaker system 11 may have their position parameters modified such that they fall in the more transparent regions of the transparency spatial response.

The processing of the signal B may also be based on user settings on the wearables 12. For example, if the user 10 has chosen a mode with low transparency, high ANC, little or no sound may be sent to the loudspeaker system 11 (signal B close to, or equal to, zero). And conversely, if the user has chosen a mode with high transparency, relatively more sound may be sent to the loudspeaker system 11.

In some embodiments, the system is capable of controlling the operation mode of the wearables 12, or, in some cases, control the settings of a specific operation mode, e.g., the parameters of the active transfer function 20. Such control may be governed by information about the loudspeaker system 11 obtained through feedback 25, and/or information about the processed signal B reproduced by the loudspeaker system 11.

If the feedback 25 specifies, to some degree of accuracy, where the loudspeakers in the loudspeaker system 11 are located (for example, using UWB or acoustic methods), the spatial response of transparency mode may be “shaped”, and e.g., be more transparent in areas where the loudspeakers are positioned. Beamforming may be used to “focus” on a specific loudspeaker. Head pose information in feedback 27 may be used to play sound from a loudspeaker that the listener 10 is looking at, or the transparency/ANC settings may be adjusted based on the look direction.

The frequency response of the transparency mode may be adjusted based on knowledge about the processed signal B. For example, the active transfer function 20 could be made more transparent in a frequency range where signal B should be more audible to the listener 10.

Similarly, the frequency response of the active transfer function 20 in active noise cancellation mode can be based on knowledge of the processed signal B. For example, the active transfer function 20 may be set not to cancel the sound from the loudspeaker system 11, whilst cancelling external background noise.

The properties of the wearables 12 may also be dynamically adjusted based on the processed signal B. For example, transparency mode could be “opened up” or ANC could be activated during particular time periods of the content.

In some embodiments, there is a communication path from the transformer 23 to the wearables 12, so that adjustments of the active transfer function 20 may be based on all available metadata (as opposed to only the metadata directly relating to audio objects rendered in signal A). Such adjustments could be based upon the property values of a specified object, an automatically determined object (i.e., the object with the highest importance level), or a combination of multiple or all objects.

The active transfer function 20 may also be modified based on parameters that are available in existing metadata formats, such as the Audio Definition Model (as defined in ITU-R BS.2076-2).

The spatial parameters (azimuth, elevation, distance) could be used, for example, to shape the spatial response of the transparency mode of the wearables 12 to “let in” sound from positions where we know there are objects. The importance parameter could be used, for example, to “open up” transparency mode when the importance of one or more objects routed to the external loudspeaker(s) passed some defined threshold. The audioContent names could be matched against a database that sets parameters in a certain way if a certain name was recognized. For example, if the input includes an active object with name MainCharacterSpeech, transparency mode could be enabled. The audioContentLanguage flag could be used, for example, to enable ANC if the external loudspeakers were playing content with a language that the user of the system did not know. This information could be set, for example, in a user profile via an appropriate app. Any of the loudnessMetadata attributes could be used, for example, to determine how much ANC should be applied. The diffuse parameter could be used, for example, to tune the directivity of the of the transparency or ANC such that more diffuse content would result in more even coverage by the processing. If application of the zoneExclusion parameter resulted in exclusion of an object from rending to the external loudspeakers, ANC could be enabled on the wearables 12.

The above parameters could be used in combination. For example, the azimuth, elevation, and distance of the audio object with the highest importance could be used to shape the directional response of the transparency mode.

The active transfer function 20 may also be modified based on metadata that is derived from the signals A and B, for example, in the transformer 23. Speech activity detection could be used, for example, to “open” the transparency mode when there was speech content active in the loudspeaker system 11. Genre detection could be used to turn on active noise cancelling when a genre that was on a “prohibited” list was recognized. Such a list could, for example, be set in a user profile via an appropriate app. Speech-to-text transcript generation could be used, for example, to turn on active noise cancelling in order to filter out swear words from speech content in the external loudspeakers. The frequency content of one or more objects sent to the loudspeaker system could be used, for example, to shape the frequency response of the transparency mode or ANC (i.e., in such a way as to enhance the blocking or passing of the external sound as desired).

The active transfer function 20 may also be modified based on specifically authored metadata. For example, a future metadata format might include specific direct control of the parameters that influence the internal transfer function, allowing a content author to directly specify their desired performance of the system for a given experience. Such a format might also include the possibility to directly author (potentially with computer assistance) any of the derived metadata discussed above.

### Contextual Combination of Wearables and Loudspeakers

The combination of wearables 12 and loudspeaker system 11 may be used to implement “late night mode”, in which the low frequency elements of the content are sent to the wearables so as not to disturb other people whilst keeping the quality of experience high for the target listener.

The battery level of the wearables 12 may be used to influence the rendering of the experience. For example, bass content may be sent predominantly to the loudspeaker system 11, when suitable speakers were available so as to save battery on the wearables 12. Also, when the wearables 12 detect that they have low battery, more work could be done by the loudspeaker system 11.

Further, the number of listeners may be used to influence the rendering of the audio content. For example, knowing that there is only one listener might suggest that the system uses primarily external loudspeakers. Creative storytelling uses could be made of the ability to send multiple listeners different aspects of the content.

### Creative Combinations of Wearables and Loudspeakers

Wearables 12 may be used to add reverberation to sound in the room, simulating a different space. For example, the wearables 12 may be used to modify the perceived position (360 degree positioning incl. close/far, internalized/externalized) of sound coming from the loudspeaker system 11.

Information may be shared between all devices in the system (including between the loudspeaker system 11 and the wearables 12) and this information may be used to drive signal processing or object allocation.

If available, room impulse response data collected by the loudspeakers' room correction may be sent to the headphones. That could, for example, be used to set parameters of a binaural engine. Microphones 19 may be used as part of the loudspeakers' room compensation process. Microphones 19 may also be used to help with loudspeaker localization.

The person skilled in the art realizes that the present invention by no means is limited to the preferred embodiments described above. On the contrary, many modifications and variations are possible within the scope of the appended claims. For example, many configurations of loudspeaker systems are possible, including surround systems and dynamically configured systems. Further, many other types of feedback may be considered, and leveraged by the processing blocks 24a, 24b to process signals A and B.

### Implementation Example

The main aim of this example is to explore the viability of using headphones or earbuds in transparency mode in combination with loudspeakers. A benefit of this form of audio reproduction is that it can supply listeners with both personal audio and shared audio over different devices. The personal audio stream could provide accessibility features such as audio description or other additional content in social settings. In other cases, the personal audio stream could be exploited in creative ways as part of a collaborative audio experience. In addition, the interaction between loudspeaker audio and headphones can lead to interesting spatial effects and increased immersion.

The concept comprised of a set of key features, which were used to guide the early prototyping work. These are outlined below.
Synchronized audio playback between headphones or earbuds and loudspeakers.
Flexible audio track (or object) routing to any device.
Audio adapts to the available devices.
The content is experienced in a domestic setting.

The content consists of a 5 minute excerpt from the science-fiction fantasy film Cosmos Laundromat. This was selected as it contains a variety of scenes within a short time period, providing plenty of creative opportunity in a short demo. In addition, high quality audio and video assets are available under a Creative Commons license.

The 120 raw audio tracks were firstly condensed down into 20 stems containing separate dialogue, music, and multiple ambience and effects tracks. These were then mixed in stereo as an initial starting point. A choice was made to focus mixing efforts on a core, predetermined configuration of devices first; this consisted of a pair of earbuds and two mono loudspeakers, one placed to the front and right of the listener and another behind and left. This approach was used to maintain a practical monitoring environment and to create a solid foundation for adaptation. A similar approach was used for the multi-device audio drama The Vostok-K Incident. Audio Orchestrator was then used to assign behaviors to the individual audio tracks which adjusted the device allocation rules based on the number of devices. Using this feature, variations of the core device setup were tested with different numbers of loudspeakers.

As this is an audiovisual experience, the general mixing philosophy used throughout mostly followed traditional film mixing techniques where important narrative audio content such as dialogue, music, and on-screen Foley tracks were allocated to the earbuds, whereas background content (e.g. atmosphere sound) was allocated to the loudspeakers. In the interest of ensuring audio and visual congruence, here the earbuds largely assume the role of the center channel in a surround sound format as the loudspeakers may not be positioned to reproduce audio within the listeners viewing angle. Outside of the traditional approach, a number of decisions were made specifically to address particular aspects of the combined earbuds and loudspeaker format. For instance, some of the ambient background objects were mirrored in the earbuds. Without any mirroring, the listener (at least with some experience) is able to distinguish between the direct earbud output and the indirect loudspeaker output. In this case, by mirroring some of the atmosphere audio tracks, a desired blending effect was achieved between the outputs of the earbuds and the loudspeakers. Overall, this increased the clarity of the atmosphere sounds while maintaining the externalization provided by the loudspeaker output. In addition to this, some effects tracks (e.g. flies in a jungle scene) were allocated to a single earbud and a loudspeaker positioned on the opposing side to the earbud selected. In particular instances such as this one, an interesting dynamic spatial effect was achieved where the two instances of the audio signal had different tonal qualities. However, this approach was only suitable for off-screen effects where audio and visual congruence was not an important factor.

Before the loudspeaker signals reach the ears, the transparency mode applies some filtering to the signals. To compensate for this, some corrective EQ was applied. A subtle high shelf at 1 KHz was used to boost the high-frequency region attenuated by the transparency mode. An additional +3 dB peak-notch filter was applied in the 200-500 Hz region.

A bespoke demonstrator system was designed to explore the concept (Section 4.2). In this case, little consideration was given as to how this concept could best be delivered in the real world. The core functionality of the demonstrator is implemented using a Max patch running on a laptop. This patch controls audio and video file playback and audio routing to defined output devices. These devices are defined using an aggregate audio device and are connected to the laptop either wirelessly over Bluetooth or WiSA, or a using a wired connection. All the audio tracks are loaded in as a single multichannel WAV file, which is subsequently unpacked into the individual signals before being routed into a 2D matrix. The matrix dimensions are defined where the number of rows corresponds to the number of audio outputs, and the columns correspond to the individual track inputs. Each cell in the matrix can be toggled manually by the user using a matrixctrl object to route the column input to the corresponding row output. Within the Max patch there is also a configurable delay parameter which can be used to manually synchronize the wired and wireless devices.

Audio allocation can be controlled manually within Max using the matrixctrl object directly or through defining audio object and device metadata through Audio Orchestrator.

The latter approach allows allocation ‘behaviors’ to be assigned to audio objects; these behaviors are then interpreted by an allocation algorithm which decides which device(s) an audio object should be assigned to. A custom build of Audio Orchestrator was created that outputs the result of the allocation algorithm as OSC data, which can then transported over UDP to the Max patch. This data is then parsed using a Max JavaScript object and used to control the matrixctrl object and the routing of the audio.

1.-25. (canceled)

26. A method for playing back an input audio content on a multi-device audio system to achieve a desired audio experience of a listener, the multi-device audio system comprising a pair of audio wearables and a loudspeaker system including at least one external loudspeaker,
wherein each audio wearable comprises a microphone configured to capture audio of a listener environment and a transducer configured to play back audio content, wherein the audio wearables are configured to operate in an active mode wherein audio captured by the microphone is processed by an active filter having an active transfer function, and wherein an output of the active filter is connected to the transducer of the audio wearable,
wherein the method comprises:
transforming the audio content into a first two-channel audio signal and a second audio signal,
playing back the first audio signal by the transducers of the audio wearables, and
playing back the second audio signal by the loudspeaker system to reach the listener over an acoustic channel via the audio wearables, the acoustic channel associated with an overall transfer function comprising the active transfer function and a position dependent transfer function associated with the position of the audio wearables relative to the external loudspeaker(s), and
based on characteristics of the second audio signal and/or the overall transfer function, processing the first audio signal and/or the second audio signal, in order to achieve the desired audio experience.

27. The method according to claim 26, further comprising receiving input associated with parameters impacting the overall transfer function, and estimating said characteristics of the overall transfer function based on said input.

28. The method according to claim 27, wherein the input includes position data describing a position of the listener with respect to the external loudspeaker(s).

29. The method according to claim 27, wherein the input includes position data describing a position of the external loudspeaker(s) with respect to the room.

30. The method according to claim 27, wherein the input includes orientation data describing a head pose of the listener.

31. The method according to claim 27, wherein the input includes an indication of a current operating mode of the audio wearables.

32. The method according to claim 27, wherein the overall transfer function further comprises a passive transfer function representing an impact on sound from the environment received directly by the listener, and wherein the input includes information related to an occluding effect of the audio wearables.

33. The method according to claim 26, further comprising controlling said active transfer function in order to achieve the desired audio experience.

34. The method according to claim 33, wherein the step of controlling the active transfer function includes controlling a current operating mode of the audio wearables.

35. The method according to claim 33, wherein the step of controlling the active transfer function includes dynamically controlling the active filter.

36. The method according to claim 26, wherein the step of transforming content includes identifying audio content that is appropriate for playback in the audio wearables, and including such content in the first audio signal.

37. The method according to claim 26, wherein the step of transforming content is based on metadata describing the loudspeaker system.

38. The method according to claim 26, wherein the audio content comprises audio objects, each audio object including an audio signal and metadata describing the audio object, and wherein the step of transforming the audio content is based on said metadata.

39. The method according to claim 26, wherein the loudspeaker system includes at least two loudspeakers and wherein the second audio signal is a multi-channel audio signal, such as a stereo signal or a surround signal.

40. A multi-device audio system for playing back an input audio content to achieve a desired audio experience of a listener, the multi-device audio system comprising:
a loudspeaker system including at least one external loudspeaker,
a pair of audio wearables, each audio wearable comprises a microphone configured to capture audio from a listener environment and a transducer configured to play back audio content, wherein the audio wearables are configured to operate in an active mode wherein audio captured by the microphone is processed by an active filter having an active transfer function, and wherein an output of the active filter is connected to the transducer of the audio wearable,
wherein the audio wearables are connected to play back a first two-channel audio signal, and
wherein the loudspeaker system is configured to play back a second audio signal to reach the listener over an acoustic channel via the audio wearables, the acoustic channel associated with an overall transfer function comprising the active transfer function and a position dependent transfer function associated with the position of the audio wearables relative to the external loudspeaker(s),
further comprising:
a transformer configured to transform the audio content into said first audio signal and said second audio signal,
a first processing block configured to process the first audio signal based on characteristics of the second audio signal and/or the overall transfer function, in order to achieve the desired audio experience, and/or
a second processing block configured to process the second audio signal based on characteristics of the second audio signal and/or the overall transfer function, in order to achieve the desired audio experience.

41. The audio system according to claim 40, further comprising at least one feedback path connected to at least one of the transformer, the first processing block and the second processing bock, said feedback path being configured to provide input associated with parameters impacting the overall transfer function.

42. The audio system according to claim 41, wherein the input includes position data describing a position of the listener with respect to the external loudspeaker(s).

43. The audio system according to claim 41, wherein the input includes position data describing a position of the external loudspeaker(s) with respect to the room.

44. The audio system according to claim 41, wherein the input includes orientation data describing a head pose of the listener.

45. The audio system according to claim 41, wherein the input includes an indication of a current operating mode of the audio wearables.

46. The audio system according to claim 41, wherein the overall transfer function further comprises a passive transfer function representing an impact on sound from the environment received directly by the listener, and wherein the input includes information related to an occluding effect of the audio wearables.

47. The audio system according to claim 40, wherein the first processing block is further configured to control said active transfer function in order to achieve the desired audio experience.

48. The audio system according to claim 46, wherein the first processing block is configured to control the active transfer function by controlling a current operating mode of the audio wearables.

49. The audio system according to claim 46, wherein the first processing block is configured to control the active transfer function by dynamically controlling the active filter.

50. The audio system according to claim 40, wherein the loudspeaker system includes at least two loudspeakers and wherein the second audio signal is a multi-channel audio signal, such as a stereo signal or a surround signal.
